(19) United States
(12) Patent Application Publication
(10) Pub. No.: US 2006/0214036 A1
(43) Pub. Date: Sep. 28, 2006

(54) Air-flow classification apparatus and method for classification

(76) Inventor: Nobuyasu Makino, Numazu-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/373,304

(22) Filed: Mar. 13, 2006

(30) Foreign Application Priority Data
Mar. 14, 2005 (JP) 2005-072037

(51) Int. Cl. B02C 19/06

(52) U.S. Cl. 241/5

(57) ABSTRACT

The present invention provides a classification apparatus which includes a hopper utiling a container with a vibrating unit allocated in a suspended state on the inner wall of the hopper and a classification means. It also provides a classification method by means of the classification apparatus.

### BACKGROUND OF THE INVENTION

1. Field of the Invention

The present invention relates to an air-flow classification apparatus and a classification method which are appropriate for classifying a toner having a small particle diameter for low-temperature fixing. More specifically, the present invention relates to a container which is appropriate for removing an adhered toner, a hopper, a filter-type filtration apparatus, a collection container and a feeder; an airflow classification apparatus for an electrophotographic powder such as electrophotographic toner which is equipped with thereof, and a classification method.

2. Description of the Related Art

Recently, there has been a growing demand for a powder or a particulate powder, and a variety of containers and apparatuses have been used to handle such powders. For example, an image forming method such as electrophotography and electrostatic photography uses a toner to develop a latent electrostatic image. In manufacturing a toner for latent electrostatic image, the final product is required to be fine particles. In order to obtain such final product by pulverizing and classifying solid particles as a raw material prescribed materials including a binding resin, a colorant such as dye, pigment and magnetic substance are dissolved and kneaded, which are then cooled for solidification, pulverized and finally classified.

Recently, in order to meet the customers' demand for high-speed printing and higher image quality in electrophotography, the specific surface area of a toner has been increasing because of the reduction in the melting point for high-speed printing and the reduction of the particle diameter for high image quality. Furthermore, it is required to load a large quantity of wax in a toner in order to comply with higher definition of a system.

In general a classification apparatus that utilizes a rotating airflow is used for classification of a particulate powder, and a dispersion separator (DS-type classification apparatus, manufactured by Nippon Pneumatic Mfg. Co., Ltd.) shown in FIG. 1 is used, for example. The manufacture of such a toner involves: a container for temporary storage of the powder; a hopper; a filter-type filtering system for solid-gas separation in powder transportation, pulverization and classification; a collecting apparatus; or a volumetric feeder of the powder. However, the increase in the specific surface area due to particle refinement and the compliance to the quality demand for the powder cause the toner to coagulate and adhere to the inner wall, and repetitive deposition and exfoliation cause problems in discharging a fixed quantity. In addition, in the conventional DS-type classification apparatus, classified coarse particles coagulate and adhere to the inner wall of the hopper during discharge, and repetitive deposition and exfoliation inhibit the discharge of a fixed amount, causing a pulsating flow, or in the worst case, adversely affect the subsequent processes.

When a particularly accurate classification is required, a closed-circuit classification is favored in which two stages of the classification apparatuses connected with transporting paths are combined in series. Therefore, the pulsating flow disturbs the circulating flow rate of the powder in the apparatuses, reducing the classification accuracy or, in the worst case, choking by the powder in the apparatuses and discontinuing the classification.

A similar phenomenon occurs in the classification step for a recently developed toner manufactured through a chemical reaction as a polymer toner without pulverization.

For example, the adhesion is prevented by processing the internal surface of a classification apparatus. Japanese Patent Application Laid-Open (JP-A) Nos. 02-294660, 02-294661, 02-294662, 02-294663 propose a fluorine resin used for classification points. However, it is not sufficient in continuous classification.

Also, JP-A Nos. 2004-113839 and 2003-280263 propose a conductive fluorine resin applied to the wall surface of a fluidized-bed pulverizer, but it is not sufficient in a continuous classification.

In addition, Japanese Utility Model Application Publication (JP-Y) No. 61-037674 proposes a method for preventing the adhesion by means of a vibrating hopper. However, the classification accuracy decreases because the apparatus as a whole is vibrated.

### SUMMARY OF THE INVENTION

The present invention is aimed at providing a classification apparatus which is advantageous in terms of manufacturing efficiency and economic aspect, where adhesion and coagulation can be suppressed in a hopper, a filter-type filtration apparatus, a collecting container or a feeder as well as in a pulverization process of manufacturing a toner for developing a latent electrostatic image having the stable charge quantity and providing favorable image quality, and the occurrence of ultra-fine powder and the contamination of coarse particles are reduced.

Moreover, the present invention aims at providing a classification method that enables an easy discharge of coarse particles from the inner wall of the hopper and a smooth discharge of the coarse particles to the subsequent processes by means of a pulsating flow.

The container of the present invention allocates a vibrating unit in a suspended state on the surface of the inner wall.

The feeder of the present invention utilizes a container which allocates a vibrating unit in a suspended state on the surface of the inner wall.

The hopper of the present invention utilizes a container which allocates a vibrating unit in a suspended state on the surface of the inner wall.

The filter-type filtration apparatus of the present invention utilizes a container which allocates a vibrating unit in a suspended state on the surface of the inner wall.

The classification apparatus is equipped with a hopper which utilizes a container with a vibrating unit in a suspended state on the surface of the inner wall and a classification means.

The method for classifying an electrophotographic powder of the present invention utilizes a classification apparatus which is equipped with a hopper containing a container with a vibrating unit in a suspended state on the surface of the inner wall and a classification means.

### BREIF DESCRIPTION OF THE DRAWINGS

FIG. 1 is a view showing an example of a conventional classification apparatus.

FIG. 2 is a view showing an example of a classification apparatus of the present invention.

FIG. 3A is an enlarged view exemplarily showing a hopper in a classification apparatus of the present invention.

FIG. 3B is an enlarged view exemplarily showing a slit location of a hopper unit in a classification apparatus of the present invention.

FIG. 4A is a view showing an example of a fitting strip in a classification apparatus of the present invention.

FIG. 4B is a view showing an example of a vibrating unit of the present invention in an attached state.

FIG. 5A is an enlarged view showing an example of a fitting strip in the hopper of the present invention.

FIG. 5B is an enlarged view showing an example of a slit-type hopper of the present invention with a fitting strip.

FIG. 6 is an enlarged view showing an example of a hopper of the present invention.

FIG. 7A is an exemplary view of a container showing a vibrating unit of the present invention attached to the container.

FIG. 7B is a single view drawing of the vibrating unit in FIG. 7A.

FIG. 7C is a single view drawing of the slit in FIG. 7A.

FIG. 8A shows an exemplary view of a vibrating unit of the present invention attached to a hopper.

FIG. 8B is a single view drawing of the vibrating unit in FIG. 8A.

FIG. 8C is a single view drawing of the vibrating unit in FIG. 8A.

FIG. 8D is a single view drawing of the slit in FIG. 8A.

FIG. 8E is a single view drawing of the slit in FIG. 8A.

FIG. 9A is an exemplary view showing a vibrating unit of the present invention attached to a filter-type filtration apparatus.

FIG. 9B is a single view drawing of the vibrating unit in FIG. 9A.

FIG. 9C is a single view drawing of the vibrating unit in FIG. 9A.

FIG. 9D is a single view drawing of the slit in FIG. 9A.

FIG. 9E is a single view drawing of the slit in FIG. 9A.

FIG. 10A is an exemplary view showing a collecting cyclone with a vibrating unit of the present invention attached to the collecting cyclone.

FIG. 10B is a single view drawing of the vibrating unit in FIG. 10A.

FIG. 10C is a single view drawing of the vibrating unit in FIG. 10A.

FIG. 10D is a single view drawing of the slit in FIG. 10A.

FIG. 10E is a single view drawing of the slit in FIG. 10A.

FIG. 11A is an exemplary view showing an attached feeder of the present invention.

FIG. 11B is a single view drawing of the vibrating unit in FIG. 11A.

FIG. 12A is an exemplary view showing a feeder utilizing a container in which a vibrating unit is suspended.

FIG. 12B is a single view drawing of the vibrating unit in FIG. 12A.

FIG. 13 is an exemplary view showing a rotary rotor classification method of the present invention.

### DESCRIPTION OF THE PREFERRED EMBODIMENTS

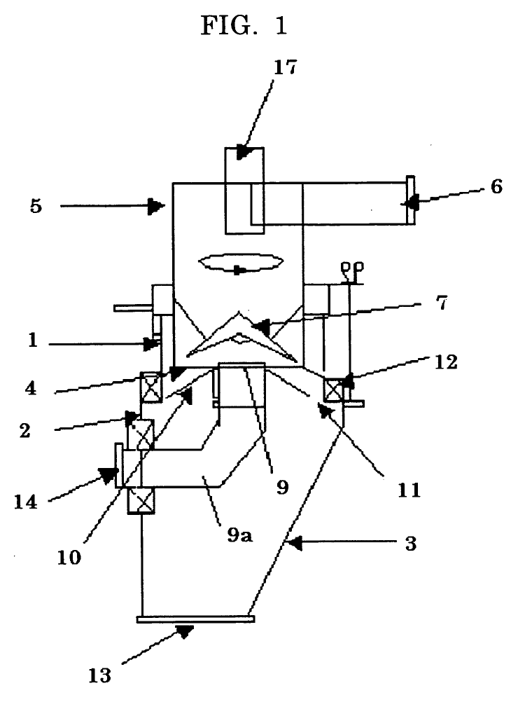

First of all, the detail of a conventional airflow DS-type classification apparatus is illustrated with reference to FIG. 1.

In FIG. 1, the airflow DS-type classification apparatus is comprised of from top, a dispersion chamber 5, a classification chamber 4 and a hopper 3.

The junction of the dispersion chamber 5 and the classification chamber 4 is retained in an upper casing 1; therefore, the dispersion chamber 5 and the classification chamber 4 are detachably attached. The junction of the classification chamber 4 and the hopper 3 is retained in a lower casing 2; therefore, the classification chamber 4 and the hopper 3 are detachably attached.

To the upper periphery of the dispersion chamber 5 attached are a dispersion chamber inlet 6 connected as an inlet from the surrounding area for supplying a primary airflow and a powder material and an exhaust pipe 17 for emitting internal gas. A conical center core 7 with its center taller than its periphery is attached inside at the lower part of the dispersion chamber 5. A separator core 10 is formed around the lower periphery of this center core 7 for guiding fine powder, and an annular coarse powder lowering aperture 11 is formed around the center core 10. A fine powder lowering aperture 9 is allocated in the central region. To the hopper 3 attached are a coarse particle outlet 13 for discharging the coarse powder from the coarse powder lowering aperture 11, and a fine particle outlet 14 of a fine powder outlet pipe 9a which discharges the fine powder guided from the fine powder lowering aperture 9.

In addition, at least one secondary airflow inlet 12 (also referred to as a louver), in which a flow path is divided into many small compartments with wing-shaped partition plates, is allocated around the lower peripheral wall of the classification chamber 4 for the inflow of a secondary airflow so that the powder material is dispersed as well as its rotation is accelerated.

The classification principle of the airflow DS-type classification method is to make use of the difference in the centrifugal force between coarse particles and fine particles in the powder material. That is, when the secondary airflow flowing in the classification chamber streams a powder material anti-freely in a swirl, the mass difference between coarse particles and fine particles is amplified for a mechanical difference by multiplying the acceleration constant based on the particles' circular motion, i.e. multiplying the mass by the square of lo the acceleration. This facilitates the separation of the coarse particles and the fine particles. Therefore, it is preferable that the coarse and fine particles dispersed in the classification chamber are promptly classified without adhesion to the inner wall of the apparatus or coagulation, that the coarse particles lose their kinetic energy and is discharged from the outlet 13, and that the fine particles are discharged from the outlet 14.

Next, the embodiment of the present invention is explained.

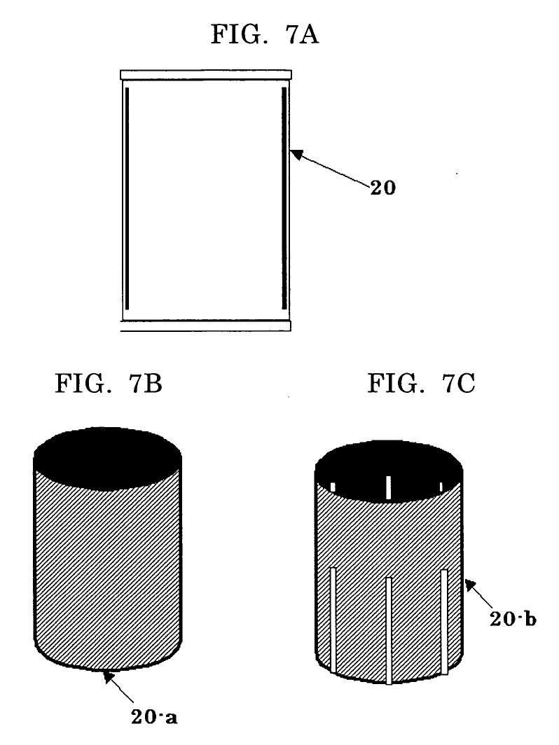

The container of the present invention contains a vibrating unit suspended on the surface of its internal wall. This is schematically illustrated in FIGS. 7A to 7C.

The adhesion strength of the powder which is adhered to the inner wall of a container is reduced by means of a vibrating unit 20 for preventing the adhesion, and the detached coarse particles are dropped promptly to the bottom of the container. In FIGS. 7B to 7C, 20-a indicates a vibrating unit, and 20-b indicates a slit-type vibrating unit.

The feeder of the present invention utilizes a container which contains a vibrating unit suspended internally on the surface of the internal wall. This is schematically illustrated in FIGS. 12A and 12B.

As shown in FIG. 12A, a powder introduced from an inlet 29-1 is discharged to an outlet 29-3 by means of discharge screws 29-2. The adhesion strength of the powder which is adhered to the inner wall of the feeder is reduced by means of a vibrating unit 29 for preventing the adhesion, and detached particles are dropped promptly to the outlet 29-3.

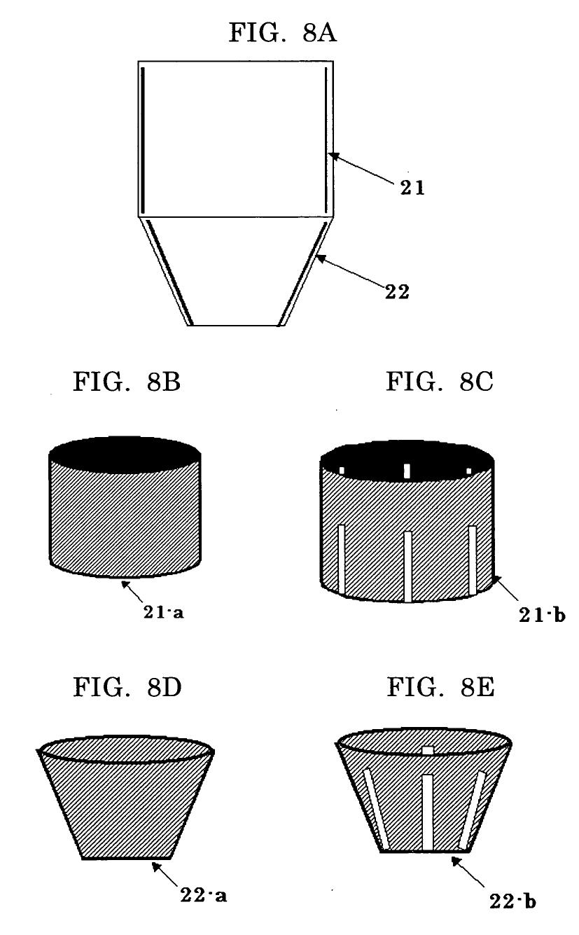

The hopper of the present invention utilizes a container which includes a vibrating unit suspended on the surface of the internal wall. This is illustrated in FIGS. 8A to 8E.

As shown in FIG. 8A, the adhesion strength of a temporarily stored powder which is adhered to the inner wall of the hopper is reduced by means of vibrating units 21 and 22 for preventing the adhesion, and detached particles are dropped promptly to the bottom of the hopper. In FIGS. 8B to 8E, 21-a and 22-a indicate vibrating units, and 21-b and 22-b indicate slit-type vibrating units.

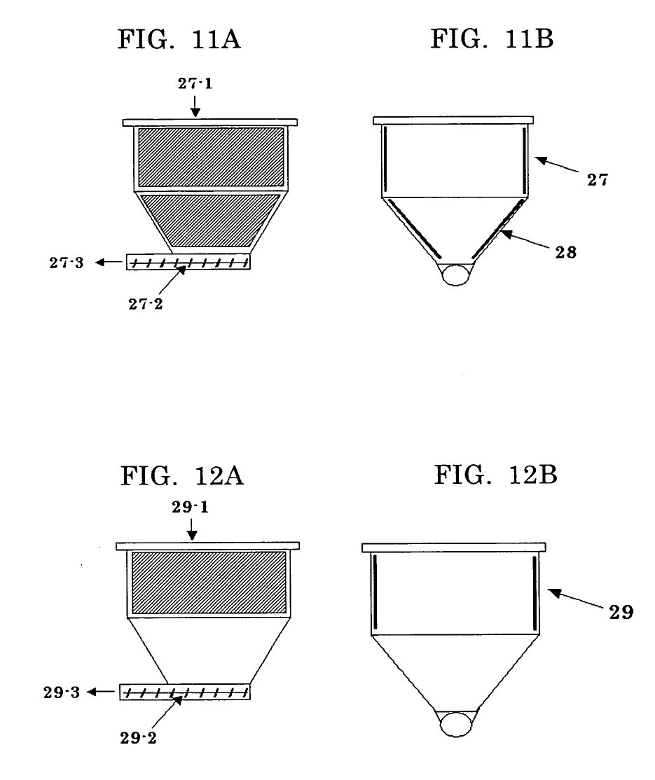

The hopper of the present invention is equipped with a feeder which utilizes a container having a vibrating unit suspended on the surface of the inner wall. This is schematically illustrated in FIGS. 11A and 11B.

As shown in FIGS. 11A and 11B, a powder introduced from an inlet 27-1 is discharged to an outlet 27-3 by means of discharge screws 27-2. The adhesion strength of the powder which adheres to the inner wall of the feeder is reduced by means of vibrating units 27 and 28 for preventing the adhesion, and the detached particles are dropped promptly to the outlet 27-3.

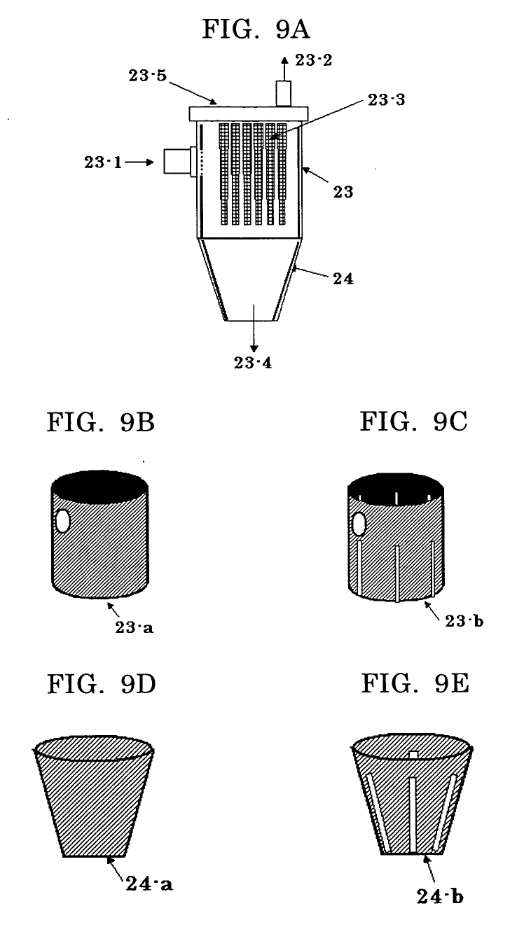

The filter-type filtration apparatus of the present invention utilizes a container having a vibrating unit suspended on the surface of the inner wall. This is schematically illustrated in FIGS. 9A to 9E.

As shown in FIG. 9A, after a powder fluid introduced from an inlet 23-1 is adsorbed to an internal filter, a fluid (airflow) is discharged to an exhaust 23-2. The adsorbed powder falls due to its own weight by means of cleaning air 23-5 injected within the filter 23-3 and is discharged from an outlet 23-4. The adhesion strength of the powder which is adhered to the inner wall of the filter-type filtration apparatus is reduced by means of vibrating units 23 and 24 for prevent the adhesion, and the detached particles are dropped promptly to the outlet 23-4. In FIGS. 9B to 9E, 23-a and 24-a indicate vibrating units, and 23-b and 24-b indicate slit-type vibrating units.

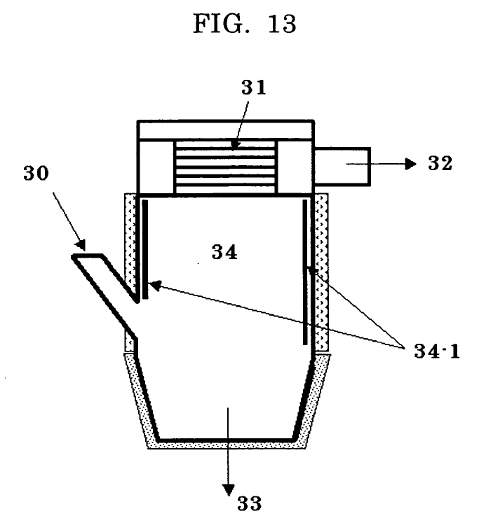

The classification apparatus of the present invention is equipped with a hopper which utilizes a container having a vibrating unit suspended on the surface of the inner wall and a classification means. This is schematically illustrated in FIG. 13.

FIG. 13 shows an example of a rotary rotor classification. A classification material supplied from a raw material inlet 30 is classified by means of a centrifugal force of a classification rotor 31 and a centripetal force of airflow sucking from the inside; subsequently, a coarse powder is discharged from a coarse particle outlet 33, and a fine powder is discharged from a fine particle outlet 32. Since a hopper 34 in the classification apparatus is equipped with a vibrating unit 34-1, there is no retention of the coarse particles in the apparatus, and stable classification accuracy is maintained. Therefore, there is no restriction in terms of method and structure as long as the classification apparatus is equipped with a hopper and a classification method.

The classification apparatus of the present invention includes: a dispersion chamber; a classification chamber below the dispersion chamber; and a hopper below the classification chamber.

The dispersion chamber includes: a dispersion chamber inlet for introducing a mixed fluid of a powder material and primary air; and an exhaust pipe for exhausting the internal air.

The classification chamber includes: a secondary airflow inlet for introducing a secondary airflow from the surrounding area; a center core allocated at the lower periphery of the center core; a separator core allocated below the outer periphery of the center core; a coarse powder lowering aperture allocated in the peripheral region; and a fine powder lowering aperture allocated in the central region.

The hopper includes: a fine powder outlet which discharges a fine powder channeled from the fine powder lowering aperture and a coarse powder outlet which discharges a coarse powder from the coarse powder lowering aperture.

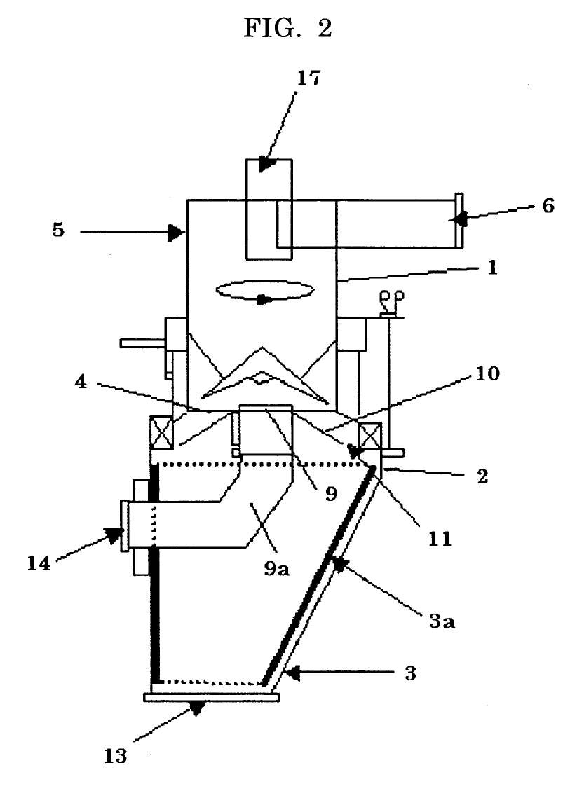

The classification apparatus of the present invention arranges a vibrating unit suspended on the surface of the inner wall of the hopper. This is schematically illustrated in FIG. 2.

The members in FIG. 2 which are equivalent to those in FIG. 1 have common reference codes, and their descriptions are omitted.

In an air-flow DS-type classification apparatus shown in FIG. 2, a hopper 3 of the present invention is equipped inside with a vibrating unit 3a having a plate thickness of 0.3 mm to 3.0 mm prepared through plate working. The adhesion strength of the powder which is adhered to the inner wall of the hopper is reduced by vibration for preventing the adhesion, and the detached coarse particles are dropped promptly to the outlet 13.

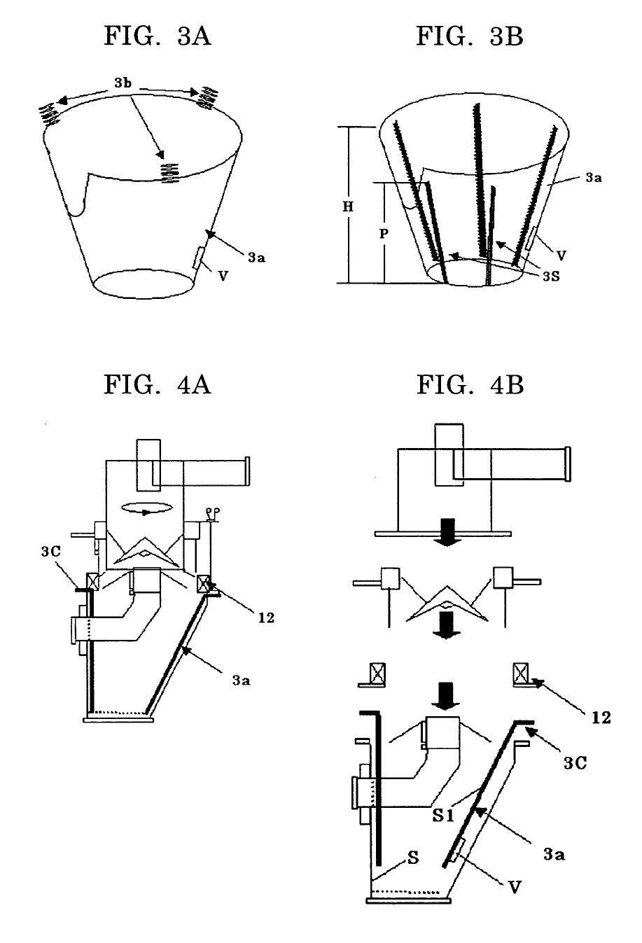

The detail of this vibrating unit 3a is explained with reference to single view drawings, FIGS. 3A and 3B. The vibrating unit 3a is arranged in a suspended state through the connection to the hopper 3 with, for example, springs 3b and has a cantilever structure so that it easily resonates with the vibrator by means of the vibration of the classification apparatus. The jig that connects the vibrating unit 3a with the hopper 3 is not restricted as long as it can easily transmit the vibration. The material can also be a rubber or a silicone, and it is not particularly restricted.

Regarding the cantilever structure, the vibrating unit 3a affects the classification accuracy if it vibrates the classification apparatus as a whole. However, the vibrating unit having a cantilever structure allows only the hopper surface to vibrate with small energy without vibrating the classification apparatus itself. Therefore, the adhesion strength of the particles is reduced, and the adhesion may be prevented.

The connection between the vibrating unit 3a and the hopper 3 is fixed, and the vibrating unit 3a preferably has a thickness of 0.3 mm to 3.0 mm in terms of resonance with the characteristic vibration.

A vibrator V is used in general for the vibrating unit 3a. There are several types of this vibrator V such as mechanical vibrator using an electromagnetic effect and pneumatic vibrator using piston or rotation, and the pneumatic vibrator is mainly used in terms of safety, functionality and operability. Also, both continuous and intermittent operations are valid as vibration mode, and the intermittent operation is mainly used in consideration of noise or energy consumption.

In the classification apparatus of the present invention, the vibrating unit has a fitting strip at least partially at its upper periphery. The fitting strip is held detachably between the upper periphery of the hopper and the lower periphery of the classification chamber so that the vibrating unit is maintained in a suspended state. This is schematically illustrated in FIGS. 4A and 4B.

This classification apparatus is equipped with a fitting strip 3c at the upper periphery of the attached vibrating unit 3a. By nipping this fitting strip 3c between the upper periphery of the hopper 3 and the lower periphery of the classification chamber 4, the vibrating unit 3a is maintained in a suspended state.

FIG. 4B is another preferable example specifically showing the method for attaching a fitting strip. A fitting strip 3c is detachably arranged and fixed between the lower surface of a secondary airflow inlet 12 of a classification chamber and the upper peripheral surface of a hopper 3. The vibrating unit 3a is cantilevered inside the hopper 3 by the vibrating unit 3a and the fitting strip 3c; therefore, the vibration is easily transmitted to the whole vibrating unit 3a.

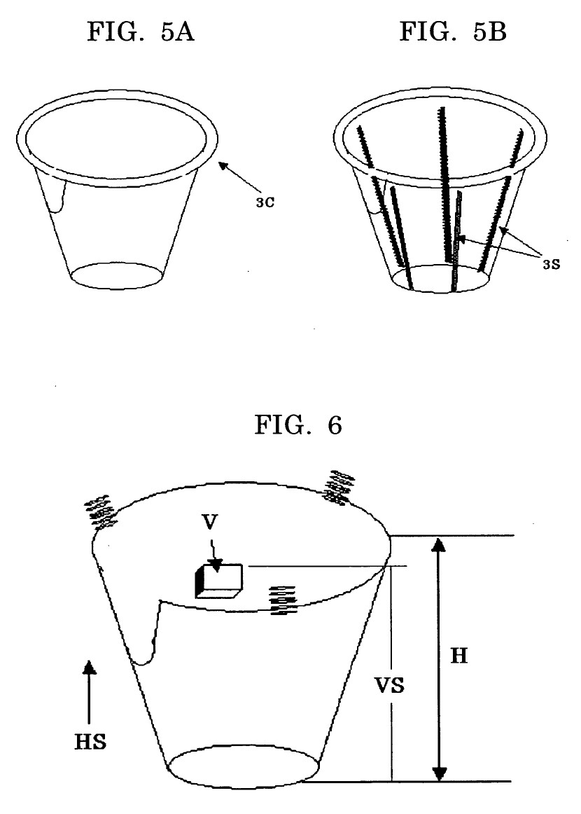

The classification apparatus of the present invention preferably has slits on the side surface of the vibrating unit. As shown in FIGS. 3B and 5B, it is possible to attach one to 10 slits 3S to the side surface of the vibrating unit 3a.

The location P of the slits 3S and the height of the hopper H have the following relation: 1/10·H≦P≦ 9/10·H. The interval between the slits 3S preferably has an equal space of two to eight splits of the circumference of the hopper so that the vibration is more easily transmitted.

The vibrating unit of the classification apparatus of the present invention is formed preferably of a conductive material.

The vibrating unit made of a conductive metal can prevent the adhesion of a powder due to frictional charge.

Examples of the conductive metal generally include SUS, Al, Cu and SS materials, but it is not restricted to these.

The surface of the vibrating unit in the classification apparatus of the present invention is preferably treated with a releasing agent. More preferably, the surface of the vibrating unit is treated with a conductive releasing agent.

The classification apparatus of the present invention is an airflow pulverization and classification apparatus characterized by the surface treatment given on the vibrating unit with the materials for as a releasing agent for suppressing the adhesion, coagulation, fusion and retention caused by pulverization in the apparatus.

The conductive releasing agent used for the treatment has an electrical resistance of 10³ Ω·cm to 10¹⁶ Ω·cm and a volumetric resistance of 10³ Ω·cm to 10¹⁶ Ω·cm. The vibrating unit is coated with fluorine resins, each having an electrical resistance of 10⁶ Ω·cm to 10⁹ Ω·cm, such as PTFE (Teflon®), tetrafluoroethylene perfluoroalkoxy vinyl ether copolymer (PFA), tetrafluoroethylene hexafluoropropylene copolymer (FEP) and ethylene tetrafluoroethylene copolymer (ETFE).

Regarding the classification apparatus of the present invention, the surface of the vibrating unit is preferably given a blasted finishing. The surface is given an abrasive finishing such as blast finishing with the materials of the vibrating unit 3a. The corrugated surface has smoothness with Ra of 0.05 μm to 1.0 μm, Ry of 1.0 μm to 5.0 μm, Rz of 1.0 μm to 5.0 μm and Rq of 0.05 μm to 1.0 μm.

The method for abrasive finishing is generally a dry blast treatment in which a particulate metallic powder of 5 μm to 50 μm or resin beads as a medium is applied to the surface with high-pressure air.

Regarding the classification apparatus of the present invention, the surface area of the vibrating unit S1 and the internal surface area of the hopper S preferably satisfy the relation, 0.30·S≦S1≦0.99·S. In order for the vibrating unit 3a in the classification apparatus to remove completely the deposition with varying powder properties, the shape, especially its surface area S1, of the vibrating unit 3a to the surface area of the hopper 3 preferably satisfies the relation, 0.30·S≦S1≦0.99·S, and more preferably, 0.6·S≦S1≦0.9·S.

In the classification apparatus of the present invention, the vibrating unit is preferably equipped with a vibrator capable of self-vibration. This apparatus is characterized by the vibrating unit 3a vibrating on its own due to a vibrator V attached on the outer surface of the vibrating unit 3a as shown in FIG. 6.

An air vibrator such as Netter Pneumatic Turbine Vibrator manufactured by ABB Co., Ltd. and an electric vibrator are generally used, but it is not limited to these.

The vibration preferably has a frequency of 3,000 min⁻¹ to 25,000 min⁻¹, and more preferably 7,000 min⁻¹ to 23,000 min⁻¹. The vibration force is preferably 1,000 N to 4,000 N, and more preferably 1,500 N to 3,000 N.

In the classification apparatus of the present invention, the position of the vibrator VS and the height of the vibrating unit H satisfies the relation, 0.3·H≦VS≦0.8·H.

The relation of the vibrator position (VS) of the classification apparatus in the HS direction relative to the height of the vibrating unit shown in FIG. 6 is 0.3·H≦VS≦0.8·H, and more preferably 0.5·H≦VS≦0.6·H.

When the vibrator position is smaller than 0.3·H in the HS direction, the vibration cannot reach the vibrating unit, and sufficient vibration cannot be transmitted. Also, when the vibrator position is greater than 0.8·H, the amplitude of the vibration to the vibrating unit increases and interferes with the hopper 3. This generates noises and metal wearing, which is not preferable.

A vibrator is used in general for the vibrating unit. There are several types of the vibrator such as mechanical vibrator using an electromagnetic effect and pneumatic vibrator using piston or rotation, and the pneumatic vibrator is mainly used in terms of safety, functionahty and operability. Also, both continuous and intermittent operations are valid as the vibration mode, and the intermittent operation is mainly used in consideration of noise or energy consumption.

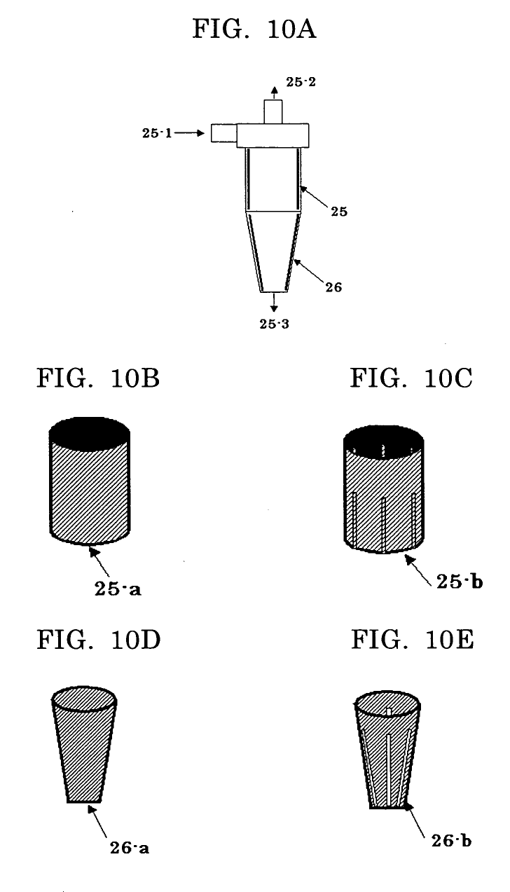

Regarding the classification apparatus of the present invention, the classification method is preferably a cyclone collector. This is schematically illustrated in FIGS. 10A to 10E.

In FIG. 10A, a powder fluid which inflows from an inlet 25-1 circulates the inner periphery due to the centrifugal effect of the rotational flow of the cyclone, and the fluid (airflow) is discharged from an exhaust 25-2. The powder falls due to its own weight as it keeps rotating, and it is discharged from an outlet 25-3. The adhesion strength of the powder which is adhered to the inner wall of the cyclone collector is reduced by means of vibrating units 25 and 26 for preventing the adhesion, and the detached coarse particles are dropped promptly to the bottom of the cyclone container. In FIGS. 10B to 10E, 25-a and 26-a indicate vibrating units, and 25-b and 26-b indicate slit-type vibrating units.

According to the present invention, the vibrating unit of the container resolves the powder adhesion in the container during storage, and it facilitates the transfer and storage of the powder.

According to the present invention, the vibrating unit of the feeder resolves the powder adhesion during storage. The powder condition in the container is stabilized, and the quantitative capability of the feeder improves.

According to the present invention, the vibrating unit of the hopper also resolves the powder adhesion in the container during storage. The powder condition in the hopper is stabilized, and the performance of the accompanying units which utilize this hopper improves. Furthermore, the hopper of the present invention enables the transfer of the powder quantitatively supplied from the feeder to the hopper for storage without altering the powder conditions.

The filter-type filtration apparatus of the present invention maintains prolonged performance of the filter-type filtration apparatus.

According to the present invention, the vibrating unit of the classification apparatus resolves the powder adhesion in the apparatus during storage, and it maintains stable classification accuracy over a prolonged period of time.

The classification apparatus of the present invention enables an easy attachment of the vibrating unit in a suspended state, which significantly improves the workability.

The use of the classification apparatus of the present invention also enables an extensive transmission of small vibration, and it further improves and stably maintains the classification accuracy.

The use of the classification apparatus of the present invention also resolves the powder adhesion due to frictional electrification as well as prevents the static electricity for ensuring safety.

The use of the classification apparatus of the present invention also improves the releasing property of the surface of the vibrating unit, which maintains the classification accuracy over a prolonged period of time and resolves the extensive adhesion inside the classification hopper.

The use of the classification apparatus of the present invention also resolves the adhesion of a toner with strong frictional electrification or adhesive property and significantly improves the safety and releasing property.

The use of the classification apparatus of the present invention resolves the extensive adhesion inside the classification hopper.

The use of the classification apparatus of the present invention can remove the adhesion regardless of operating status of the apparatus.

The use of the classification apparatus of the present invention can remove the extensive adhesion regardless of operating status of the apparatus.

The use of the classification apparatus of the present invention can provide a toner with sharpness having reduced discreteness.

The use of the classification apparatus of the present invention can provide a classified toner with high product yield.

The present invention will be illustrated hereinafter in more detail with reference to the status of the classification by the classification apparatus of the present invention as examples. These are simply one aspect of the present invention and not to be construed as limiting the technical scope of the present invention.

The examples below show the degree of classification for a given operating time period or the efficiency based on the operation until a certain condition is reached.

### EXAMPLE 1

A mixture of 70% by mass of styrene-acrylic copolymer resin, 10% by mass of polyester resin, 5% by mass of carnauba wax and 15% by mass of carbon black was dissolved and kneaded in a roller mill After it was cooled and solidified, the mixture was coarsely pulverized in a hummer mill.

Next, this coarse grind was finely pulverized in a jet mill so that the resulting grind had a mass average pulverized particle diameter of 6.4 μm. The fine grind was transferred to a container. As for the vibration conditions, the vibration frequency of 21,000 min⁻¹ and the vibration force of 2,200 N were used.

No toner adhesion and segregation to the inner walls of the container and the feeder were observed.

### EXAMPLE 2

A mixture of 70% by mass of styrene-acrylic copolymer resin, 10% by mass of polyester resin, 5% by mass of carnauba wax and 15% by mass of carbon black was dissolved and kneaded in a roller mill. After it was cooled and solidified, the mixture was coarsely pulverized in a hummer mill.

Next, this coarsely pulverized powder was finely pulverized in a jet mill so that the resulting finely pulverized powder had a mass average pulverized particle diameter of 6.0 μm.

As for the vibration conditions, the vibration frequency of 21,000 min⁻¹ and the vibration force of 2,200 N were used.

This finely pulverized powder was classified in an airflow DS-type classification apparatus in FIG. 2.

The obtained powder had a mass average pulverized particle diameter of 6.4 μm, and the quantitative content of submicron particles having a particle diameter of 4 μm or less was 10%.

The pulverized and classified powder was filtered with a filter-type filtration apparatus shown in FIG. 9 with the same vibration conditions as the pulverization and classification processes, i.e. vibration frequency of 21,000 min⁻¹ and vibrating force of 2,200 N, and the powder discharge of the filter-type filtration apparatus was 99.5%.

### EXAMPLE 3

A mixture of 70% by mass of styrene-acrylic copolymer resin, 10% by mass of polyester resin, 5% by mass of carnauba wax and 15% by mass of carbon black was dissolved and kneaded in a roller mill. After it was cooled and solidified, the mixture was coarsely pulverized in a hummer mill.

Next, this coarse grind was finely pulverized in a jet mill so that the resulting grind had a mass average pulverized particle diameter of 6.4 μm.

As for the vibration conditions, the vibration frequency of 21,000 min⁻¹ and the vibration force of 2,200 N were used.

This finely pulverized powder was classified in an airflow DS-type classification apparatus in FIG. 2.

The obtained powder had a mass average pulverized particle diameter of 6.8 μm, and the quantitative content of submicron particles having a particle diameter of 4 μm or less was 8%.

The pulverized and classified powder was filtered with a cyclone shown in FIG. 10A with the same vibration conditions as the pulverization and classification processes, i.e. vibration frequency of 21,000 min⁻¹ and vibrating force of 2,200 N, and the powder discharge of the filter-type filtration apparatus was 99.0%.

### EXAMPLE 4

A mixture of 70% by mass of styrene-acrylic copolymer resin, 10% by mass of polyester resin, 5% by mass of carnauba wax and 15% by mass of carbon black was dissolved and kneaded in a roller mill. After it was cooled and solidified, the mixture was coarsely pulverized in a hummer mill.

Next, this coarsely pulverized powder was finely pulverized in a jet mill so that the resulting finely pulverized powder had a mass average pulverized particle diameter of 6.4 μm.

The obtained finely pulverized powder was classified in an air-flow DS-type classification apparatus in FIG. 2 using a feeder shown in FIG. 11. As for the vibration conditions, the vibration frequency of 21,000 min⁻¹ and the vibration force of 2,200 N were used.

The obtained powder had a mass average pulverized particle diameter of 6.8 μm, and the quantitative content of submicron particles having a particle diameter of 4 μm or less was 9%.

### EXAMPLE 5

A mixture of 70% by mass of styrene-acrylic copolymer resin, 10% by mass of polyester resin, 5% by mass of carnauba wax and 15% by mass of carbon black was dissolved and kneaded in a roller mill. After it was cooled and solidified, the mixture was coarsely pulverized in a hummer mill.

Next, this coarsely pulverized powder was finely pulverized in a jet mill so that the resulting finely pulverized powder had a mass average pulverized particle diameter of 6.4 μm.

As the vibration conditions, the vibration frequency of 21,000 min⁻¹ and the vibration force of 2,200 N were used.

This finely pulverized powder was classified in an air-flow DS-type classification apparatus shown in FIG. 2.

The obtained powder had a mass average pulverized particle diameter of 6.8 μm, and the quantitative content of submicron particles having a particle diameter of 4 μm or less was 8%.

### COMPARATIVE EXAMPLE 1

The classification was performed with the equivalent conditions as those in Example 5 except that the classification apparatus in Example 5 was replaced by a conventional classification apparatus shown in FIG. 1. The operation time of one hour resulted in a mass average pulverized particle diameter of 6.90 μm, and the quantitative content of submicron particles having a particle diameter of 4 μm or less was 10%. After two hours of operation, the quantitative content of submicron particles having a particle diameter of 4 μm or less increased to 12%. There was toner adhesion observed inside the hopper of the apparatus.

### EXAMPLE 6

A finely pulverized powder obtained through the same kneading and pulverization as those in Example 5 was classified with an airflow DS-type classification apparatus shown in FIG. 2.

The obtained powder had a mass average pulverized particle diameter of 6.8 μm, and the quantitative content of submicron particles having a particle diameter of 4 μm or less was 8%.

### EXAMPLE 7

A finely pulverized powder obtained through the same kneading and pulverization as those in Example 5 was classified with an airflow DS-type classification apparatus shown in FIG. 4. The obtained powder had a mass average pulverized particle diameter of 6.7 μm, and the quantitative content of submicron particles having a particle diameter of 4 μm or less was 7.5%.

### EXAMPLE 8

A finely pulverized powder obtained through the same kneading and pulverization as those in Example 5 was introduced in a vibrating unit made of a copper plate having a conductivity of 95%, and the hopper was operated for 10 hours. The obtained powder had a mass average pulverized particle diameter of 6.85 μm, and the quantitative content of submicron particles having a particle diameter of 4 μm or less was 8%.

### EXAMPLE 9

A finely pulverized powder was obtained through the same kneading and pulverization as those in Example 5. A vibrating unit made of a copper plate having a conductivity of 95% was coated with a fluorine resin having an electric resistance of 10⁸ Ω·cm and a volumetric resistance of 10⁶ Ω·cm. The finely pulverized powder was introduced in the hopper, which was operated for 12 hours. The obtained powder had a mass average pulverized particle diameter of 6.8 μm, and the quantitative content of submicron particles having a particle diameter of 4 μm or less was 7.5%.

### EXAMPLE 10

A finely pulverized powder was obtained through the same kneading and pulverization as those in Example 5. A vibrating unit was made of a copper plate having a conductivity of 95%, and its corrugated surface was blasted for Ra of 0.10 μm, Ry of 3.0 μm, Rz of 3.0 μm and Rq of 3.0 μm. The finely pulverized powder was introduced in the hopper, which was operated for 15 hours. The obtained powder had a mass average pulverized particle diameter of 6.8 μm, and the quantitative content of submicron particles having a particle diameter of 4 μm or less was 7.0%.

### EXAMPLE 11

A finely pulverized powder was obtained through the same kneading and pulverization as those in Example 5. A hopper with a vibrating unit was prepared, where the surface area of the vibrating unit (S1) with respect to the surface area of the hopper (S) had a relation, 0.8·S. The finely pulverized powder was introduced in the hopper, which was operated for 15 hours. The obtained powder had a mass average pulverized particle diameter of 6.7 μm, and the quantitative content of submicron particles having a particle diameter of 4 μm or less was 7.0%.

### EXAMPLE 12

A finely pulverized powder was obtained through the same kneading and pulverization as those in Example 5. The finely pulverized powder was introduced in a hopper, which was operated at a vibration frequency of 22,500 min⁻¹ and a vibration force of 500 N to 5,000 N for 15 hours. The obtained powder had a mass average pulverized particle diameter of 6.7 μm, and the quantitative content of submicron particles having a particle diameter of 4 μm or less was 7.0%.

### EXAMPLE 13

A finely pulverized powder was obtained through the same kneading and pulverization as those in Example 5. A hopper with a vibrating unit was prepared, where a vibrator was attached to the vibrating unit at a height of 0.5·H with respect to the height of the hopper H in the direction of HS. The finely pulverized powder was introduced in the hopper, which was operated at a vibration frequency of 22,500 min⁻¹ and a vibration force of 500 N to 5,000 N for 15 hours. The obtained powder had a mass average pulverized particle diameter of 6.7 μm, and the quantitative content of submicron particles having a particle diameter of 4 μm or less was 6.5%.

What is claimed is:

1. A container comprising a vibrating unit allocated in a suspended state on the surface of the inner wall of the container.

2. A feeder comprising a container, wherein the container comprises a vibrating unit allocated in a suspended state on the surface of the inner wall of the container.

3. A hopper comprising a container, wherein the container comprises a vibrating unit allocated in a suspended state on the surface of the inner wall of the container.

4. The hopper according to claim 3, wherein the hopper comprises a feeder at the bottom of the hopper, and the feeder comprises a vibrating unit allocated in a suspended state on the surface of the inner wall of the feeder.

5. A filtertype filtration apparatus comprising a container, wherein the container comprises a vibrating unit allocated in a suspended state on the surface of the inner wall of the container.

6. A classification apparatus comprising:
a hopper comprising a vibrating unit allocated in a suspended state on the surface of the inner wall of the hopper, and
a classification unit.

7. The classification apparatus according to claim 6, wherein the classification apparatus comprises a dispersion chamber; a classification chamber below the dispersion chamber; and a hopper below the classification chamber,
wherein the dispersion chamber comprises: a dispersion chamber inlet for introducing a mixed fluid of a powder material and a primary airflow; and an exhaust pipe for emitting internal gas;
the classification chamber comprises: a secondary airflow inlet for introducing a secondary airflow from the surrounding area; a center core in a conical shape; a separator core formed around the lower periphery of the center core; a coarse powder lowering aperture formed in the surrounding region; and a fine powder lowering aperture formed in the central region;
the hopper comprises a coarse particle outlet for discharging a coarse powder guided from the coarse powder lowering aperture; and a fine particle outlet for discharging a fine powder guided from the fine powder lowering aperture; and
the hopper comprises a vibrating unit allocated in a suspended state on the surface of the inner wall of the hopper.

8. The classification apparatus according to claim 6,
wherein the vibrating unit comprises a fitting strip at least partially at the upper periphery of the vibrating unit, and the vibrating unit is maintained in a suspended state by the fitting strip nipped detachably between the upper periphery of the hopper and the lower periphery of the classification chamber.

9. The classification apparatus according to claim 6,
wherein the vibrating unit comprises slits.

10. The classification apparatus according to claim 6, wherein the vibrating unit is formed of a conductive material.

11. The classification apparatus according to claim 6, wherein the surface of the vibrating unit is treated with a releasing agent.

12. The classification apparatus according to claim 6, wherein the surface of the vibrating unit is treated with a conductive releasing agent.

13. The classification apparatus according to claim 6, wherein the surface of the vibrating unit is given a blasted finishing.

14. The classification apparatus according to claim 6, wherein the surface area of the vibrating unit S1 and the internal surface area of the hopper S satisfy the relation, 0.30·S≦S3≦0.99·S.

15. The classification apparatus according to claim 6, wherein the vibrating unit is equipped with a vibrator capable of self-vibration.

16. The classification apparatus according to claim 6, wherein the position of the vibrator VS and the height of the vibrating unit H satisfies the relation, 0.3·H≦VS≦0.8·H.

17. The classification apparatus according to claim 6, wherein the classification means is a cyclone collector.

18. A method for classifying a powder for electrophotography comprising a hopper and a classification apparatus,
wherein the hopper comprises a vibrating unit allocated in a suspended state on the surface of the inner wall of the hopper, and
the classification apparatus comprises a classification means
